(19) United States
(12) Patent Application Publication
(10) Pub. No.: US 2025/0215209 A1
(43) Pub. Date: Jul. 3, 2025

(54) RUBBER COMPOUNDS OF FUNCTIONALIZED CONJUGATED DIENE RUBBERS AND SILICA FILLERS

(71) Applicant: ARLANXEO DEUTSCHLAND GMBH, Dormagen (DE)

(72) Inventors: Susanna LIEBER, Kaiserslautern (DE); Thomas RUENZI, Düsseldorf (DE); Dave HARDY, LEIDERDORP (NL)

(73) Assignee: ARLANXEO DEUTSCHLAND GMBH, (US)

(21) Appl. No.: 18/850,164

(22) PCT Filed: May 26, 2023
(86) PCT No.: PCT/EP2023/064188

§ 371 Date: Sep. 24, 2024

(30) Foreign Application Priority Data
May 27, 2022 (EP) 22175759.4

(51) Int. Cl. C08L 55/00; B60C 1/00; C08F 2/04; C08F 290/04; C08K 3/36

(52) U.S. Cl. CPC C08L 55/00; B60C 1/0016; C08F 2/04; C08F 290/044; C08K 3/36

(57) ABSTRACT

Rubber compounds comprising a conjugated diene polymer and a silica filler, wherein the silica filler has a content of SiO₂ of at least 80% by weight based on the weight of the filler and is obtained from a biomass ash comprising rice husk ash and wherein the conjugated diene polymer is a homopolymer of a conjugated diene or a copolymer of at least one conjugated diene selected from the group consisting of butadiene, isoprene, 1,3-pentadiene, 2,3-dimethyl-butadiene, 1-phenyl-1,3-butadiene, 1,3-hexadiene, and wherein the polymer is functionalized and comprises at least one functional group. Also provided are methods making a vulcanizable rubber compound comprising combining the conjugated diene polymer with the silica, and methods making an article comprising subjecting a curable composition comprising the compound and a curing agent capable of curing the conjugated diene polymer to at least one curing reaction.

This application is a 371 of PCT/EP2023/064188, filed May 26, 2023, which claims priority benefit under 35 U.S.C. § 119 of the European Patent Application No. 22175759.4, filed May 27, 2022, the disclosures of which are incorporated herein by reference.

### BACKGROUND

Synthetic rubbers are used in many different applications. They are typically combined with one or more fillers to produce rubber compounds which are then shaped into articles or combined with other ingredients to produce articles. A major application of synthetic rubbers includes tires or components of tires such as tire treads. Typically, conjugated diene rubbers are homopolymers of conjugated dienes or copolymers of at least one conjugated diene monomer are used for this purpose.

There is a continuous need to improve the properties of tires and in particular the properties of tire treads. It has now been found that a combination of conjugated diene rubbers that are functionalized to contain at least functional group with a specific silica filler can be used advantageously for making rubber compounds for producing tires or tire treads.

### SUMMARY

Therefore, in one aspect there is provided a method for producing a rubber comprising combining a conjugated diene polymer and a silica filler, wherein the silica filler has a content of SiO₂ of at least 80% by weight based on the weight of the filler and is obtained from a biomass ash comprising rice husk ash and wherein the conjugated diene polymer is a homopolymer of a conjugated diene or a copolymer of at least one conjugated diene selected from the group consisting of butadiene, isoprene, 1,3-pentadiene, 2,3-dimethylbutadiene, 1-phenyl-1,3-butadiene, 1,3-hexadiene, and wherein the polymer is functionalized and comprises at least one functional group that comprises at least one polar group selected from —OX, —OR, —COOX, —COOR, —N(R′₁)(R′₂)Xₙ or a combination thereof, wherein X represents H or a cation, n is either 1 or 0 and in case n is 1 the nitrogen atom N is positively charged, R represents a C1-C6 alkyl group, R′₁ and R′₂ represent independently from each other H, a C₁-C₆ alkyl group a —Si(R′₄)(R′₅) group where R′₄ and R′₅ represent independently from each other a C₁-C₆ alkyl group.

In another aspect there is provided a rubber compound obtained by the method.

In a further aspect there is provided a method of making an article comprising subjecting a curable composition comprising the compound and a curing agent capable of curing the conjugated diene polymer to at least one curing reaction.

In another aspect there is provided an article obtained by a process comprising curing a composition comprising the compound wherein the process comprises at least one shaping step wherein the shaping may take place prior to, during or after the curing.

### DETAILED DESCRIPTION

In the following description the terms “comprising”, “containing”, “including”, “having” are intended to have an open meaning allowing, for example, for the presence of additional ingredients, components, steps or procedures. For example, a composition “comprising ingredient X” is meant to describe a composition that includes ingredient X but that, optionally, includes additional ingredients other than ingredient X. For a closed meaning the term “consisting of” is used. A composition “consisting of ingredient X” is meant to include ingredient X but no other ingredients.

In the following description norms may be used. If not indicated otherwise, the norms are used in the version that was in force on Mar. 1, 2020. If no version was in force at that date because, for example, the norm has expired, the version is referred to that was in force at a date that is closest to Mar. 1, 2020.

In the following description the amounts of ingredients of a composition or polymer may be indicated interchangeably by “weight percent”, “wt. %” or “% by weight”. The terms “weight percent”, “wt. %” or “% by weight” are based on the total weight of the composition or polymer, respectively, which is 100% unless indicated otherwise.

The term “phr” means parts per hundred parts of rubber, i.e., the weight percentage based on the total amount of rubber which is set to 100.

Ranges identified in this disclosure include and disclose all values between the endpoints of the range and include the end points unless stated otherwise.

The term “substituted” is used to describe hydrocarbon-containing organic compounds where at least one hydrogen atom has been replaced by a chemical entity other than a hydrogen. That chemical entity is referred to herein interchangeably as “substituent”, “residue” or “radical”. For example, the term “a methyl group substituted by fluorine” refers to a fluorinated methyl group and includes the groups —CF₃, —CHF₂ and —CH₂F. The term “unsubstituted” is meant to describe a hydrocarbon-containing organic compound of which none of its hydrogen atoms have been replaced. For example, the term “unsubstituted methyl residue” refers to a methyl, i.e. —CH₃.

### Conjugated Diene Polymers

The conjugated diene polymers according to the present disclosure can be obtained by a polymerization reaction comprising the polymerization of at least one conjugated diene as monomer. Preferably, the diene polymer is a homopolymer or a copolymer of at least one conjugated diene, preferably selected from 1,3-butadiene, isoprene, 1,3-pentadiene, 2,3-dimethylbutadiene, 1-phenyl-1,3-butadiene, 1,3-hexadiene. 1,3-Butadiene and/or isoprene are particularly preferred.

In one embodiment of the present disclosure the diene polymer is a polybutadiene homopolymer, more preferably a 1,3-butadiene homopolymer. In another embodiment of the present disclosure the diene polymer is a 1,3-butadiene-copolymer.

In another embodiment of the present disclosure the diene polymer is a copolymer of a conjugated diene, preferably butadiene, wherein the copolymer comprises units derived from one or more conjugated diene as described above and/or one or more vinyl aromatic monomer, and, optionally, one or more units derived from one or more other comonomers. Examples of vinylaromatic monomers include, but are not limited to, styrene, ortho-methyl styrene, meta-methyl styrene, para-methyl styrene, para-tertbutyl styrene, vinyl naphthalene, and combinations thereof. Styrene is particularly preferred.

The vinylaromatic monomers also include substituted vinyl aromatic monomers where one or more hydrogen atoms of the vinyl aromatic monomer have been replaced by a heteroatom or groups having one or more heteroatoms, preferably selected from Si, N, O, H, Cl, F, Br, S and combinations thereof. Substituted monomers also include vinyl aromatic monomers having one or more functional groups with one or more heteroatoms or units containing at least one functional group with one or more heteroatom. Preferably, the heteroatoms are selected from Si, N, O, H, Cl, F, Br, S and combinations thereof. Examples of functional groups include but are not limited to hydroxy, thiol, thioether, ether, halogen carboxylic acid groups or salt thereof and combinations thereof. Such functionalized conjugated monomers are preferably copolymerized with one or more of the vinylaromatic monomers described above.

In a preferred embodiment the diene polymer according to the present disclosure comprises repeating units derived from 1,3-butadiene and styrene.

Preferably, the polymers according to the present disclosure contain at least 50% by weight, preferably at least 60% by weight, based on the weight of the polymer, of units derived from 1,3-butadiene. In one embodiment of the present disclosure the diene polymers contain at least 60% by weight, or at least 75% by weight units derived from 1,3-butadiene. In one embodiment the polymer according to the present disclosure comprises at least 75% or at least 95% by weight of units derived from one or more than conjugated diene monomers.

In one embodiment of the present disclosure the diene polymers contain from 0 to 49% by weight, or from 0% to 40% by weight, based on the total weight of the polymer, of units derived from one or more comonomers.

In one embodiment the diene polymers of the present disclosure contain from 0 to 20% by weight of units derived from one or more conjugated dienes other than 1,3 butadiene.

In one embodiment the diene polymers according to the present disclosure contain at least 50% by weight, preferably at least 60% by weight, based on the weight of the polymer, of units derived from 1,3-butadiene and at least 5% by weight, and preferably up to 49% by weight, of units derived from one or more vinyl aromatic comonomer, preferably from 5% to 40% by weight, or from 10% to 35% by weight, of units derived from one or more vinyl aromatic comonomer, preferably a styrene. Optionally, such polymers may comprise from 0 to 25% by weight of one or more other comonomer with the proviso that the total amount of monomers is adjusted such that the polymer still has a total weight of 100%. In one embodiment the polymer according to the present disclosure comprises from 55% to 92% by weight of units derived from one or more conjugated diene monomers and from 5.8% to 45% by weight of units derived from vinyl aromatic comonomers.

Suitable other conjugated dienes as comonomer include but are not limited to myrcene, ocimenes and/or farnesenes. The conjugated dienes also include substituted conjugated dienes, where one or more hydrogen atoms of the diene have been replaced by groups containing one or more heteroatoms selected from Si, N, O, H, Cl, F, Br, S and combinations thereof or functional groups containing one or more heteroatoms, for example functional groups having one or more heteroatoms selected from Si, N, O, H, Cl, F, Br, S and combinations. Examples of functional groups include but are not limited to hydroxy, thiol, thioether, ether, halogen, amine, silane and units having one or more carboxylic acid groups or salts thereof and combinations thereof. Such functionalized conjugated dienes are preferably copolymerized with one or more of the conjugated dienes described above.

Suitable copolymerizable comonomers further include one or more alpha-olefins, for example, ethene, propene. 1-butene, 1-pentene, 1-hexene, 4-methyl-1-pentene. 1-octene and combinations thereof. In one embodiment, the diene polymers according to the present disclosure contain from 0 to 20% by weight of units derived from one or more alpha-olefins.

Suitable comonomers also include, but are not limited to, one or more other co-polymerizable comonomers that introduce functional groups-other than the functional comonomers above-including cross-linking sites, branching sites, branches or functionalized groups. In one embodiment of the present disclosure the diene polymers contain from 0% to 10% by weight or from 0% to 5% by weight of units derived from one or more of such other comonomers. Such comonomers include, for example, divinyl benzene, trivinyl benzene, divinyl naphthalene.

Combinations of one or more of comonomers of the same chemical type as described above as well as combinations of one or more comonomers from different chemical types may be used. In one embodiment of the present disclosure the other comonomers described above are absent or the polymer comprises less than 10% by weight, less than 5% by weight or not more than 1% by weight of units derived from them.

Butadiene and some or all of the other monomers used to produce the polymers according to the present disclosure may be obtained from a fossil resource or from a sustainable resource. A sustainable resource includes renewable materials, including plant-based materials or materials produced by organisms including fungi, microbes and extremophiles, or enzymes, in which case the monomer is also referred to as a “bio-based monomer”. A sustainable resource also includes a recycled material, as is the case, for example, with ISCC+-certified product. The recycled material may include recycled plant-based materials and recycled materials that are not plant-based, for example materials obtained from the conversion of plastic waste or rubber waste, including the pyrolysis of tires. The chemical and mechanical properties of polymers obtained with materials obtained from a sustainable resource do not differ from those obtained with materials from a fossil resource. The physical properties of the polymer are also identical, except that monomers obtained from plant-based materials may have a different amount of the carbon 14 isotope than those obtained from fossil resources. However, using monomers from a sustainable resource may increase the biological content of the polymers and in any case reduces the carbon dioxide footprint of the polymer and thus contributes to the reduction of carbon dioxide generation. While monomers obtained from a sustainable resource can replace monomers from a fossil source, the use of monomers obtained from a sustainable resource may require additional purification steps to remove impurities from their production process. Such purification processes are known to the person skilled in the art and include but are not limited to distillation, absorption on resins or other absorbents and a combination thereof.

The diene polymers according to the present disclosure preferably have an average molecular weight (number average, Mn) of 10,000 to 2,000,000 g/mol, preferably of 100,000 to 1,000,000 g/mol.

Preferably, the diene polymers according to the present disclosure have a glass transition temperature (Tg) of from about −110° C. to about +20° C., preferably of from about −110° C. to about 0° C.

Preferably, the diene polymers according to the present disclosure have a Mooney viscosity [ML 1+4 (100° C.)] of from about 10 to about 200, preferably from about 30 to about 150 Mooney units.

The polymers typically have a dispersity from about 1.03 to about 3.5.

The diene polymers can be prepared by methods known in the art. Preferably the polymers can be obtained by a process comprising an anionic solution polymerization or a polymerization using one or more coordination catalysts. The polymerization may be carried out in solution or in the gas phase. Coordination catalysts include Ziegler-Natta catalysts or monometallic catalyst systems. Preferred coordination catalysts are those based on Ni, Co, Ti, Zr, Nd, V, Cr, Mo, W or Fe.

The conjugated diene polymer is functionalized. The functionalized conjugated diene polymers can be prepared, for example, by a reaction involving the addition of at least one functionalization agent to reactive polymer chains produced by a polymerization of conjugated monomers and may be followed by the addition of at least one further functionalization agent as known in the art. In one embodiment the at least one functional group is created by a coupling agent that is designed to additionally create at least one functional group and the functionalized polymer is also coupled polymer. A coupling agent may link two or more polymer chains together via reaction with the coupling agent. In one embodiment the functional group has been created by a functionalizing agent that is not a coupling agent. In one embodiment of the present disclosure the polymer is obtained by using a coupling agent that also creates a functional group in combination with, simultaneously or subsequently, one or more functional agent to generate a terminal functional group. In one embodiment of the present disclosure the polymer is a coupled polymer, wherein the coupled polymer may be produced by using a coupling agent that creates a functional group or a coupling agent that does not create a functional group. In one embodiment the polymer according to the present disclosure is not a coupled.

Preferably, the diene polymer has been functionalized by one or more appropriate functionalization agent to create a functional group at a terminal end of the polymer or as a side group or as part of a coupled polymer. Preferably, the functional group comprises from 1 to 20 silicon atoms and comprises, in addition to carbon and hydrogen atoms, optional heteroatoms selected from O, N and S. Preferably, the polymer has been functionalized to have at least one terminal functional group, which may be situated at an alpha position or at an omega position of the polymer or both. Preferably, the functional group comprises from 1 to 50 carbon atoms, more preferably the functional group comprises from 1 to 12 silicon atoms and from 1 to 30 carbon atoms and optionally may further comprise one or more than one heteroatom selected from S and N or a combination thereof.

Preferably, the functional group comprises at least one group selected from the formulae *—Si(R¹)(R²)—C(R³)(R⁴)—, *—Si(R¹)(R²)—O—Si(R³)(R⁴)— or a combination thereof wherein R¹, R², R³, R⁴ are identical or different and are selected from H, and C₁-C₁₂ alkyl groups that, optionally, comprise heteroatoms selected from O, N, S, and Si, for example as alkoxy groups, trialkyl silyl groups, alkyl amino groups, dialkyl amino groups and combinations thereof, and where *-represents a bond to a polymer chain and wherein at least one of R¹ and R² may also represent a chain of the polymer.

Preferably the functional group further comprises at least one polar group selected from —OX, —OR, —COOX, —COOR, —SX, —N(R′₁)(R′₂) or a combination thereof, wherein X represents H or a cation, R represents a C1-C6 alkyl group, R′₁ and R′₂ represent independently from each other H, a C₁-C₆ alkyl group a —Si(R′₄)(R′₅) group where R′₄ and R′₅ represent independently from each other a C₁-C₆ alkyl group. More preferably, the functional group comprises at least one polar group that can be converted into an ionic group or is present as an ionic group. Preferred examples include —COOX, —N(R′₁)(R′₂) groups and a combination thereof.

In one embodiment the functional group comprises at least one silyl, silanol or siloxane group selected from: —SiH₂(OH), —SiR₂(OH), —SiH(OH)₂, —SiR₁(OH)₂, —Si(OH)₃, —Si(OR₁)S, —(SiR₁R₂O)ₓ—R₃, —Si(R₃)₃₋ₘ(X)ₘ, where X is a halogen, x is the number of repetitive units between 1 and 30, m is the number of linked groups, varying from 0 to 3, R₁ and R₂ are identical or different, and can be alkoxy or alkyl, linear or branched, cycloalkyl, aryl, alkylaryl, aralkyl or vinyl groups, in each case having 1 to 20 carbon atoms, and R: is H or alkyl, linear or branched, in each case having 1 to 20 carbon atoms, or a mononuclear aryl group.

In one embodiment the functional group comprises or consists of a group represented by the formula

[—Si(R₁R₂)—O—]ₙ—Si(R₁R₂)—OH,

where R₁ and R₂ are identical or different, and can be alkoxy or alkyl, linear or branched, cycloalkyl, aryl, alkylaryl, aralkyl or vinyl groups, in each case having 1 to 20 carbon atoms, and n represents the number of units of the siloxane functional group before a silanol terminal group, varying from 1 to 49, preferably 1 to 29.

In one embodiment the functional group comprises or consists of a group represented by the formula:

*—Si(A²-N((H)ₖ(Rᵢ)₂₋ₖ))_{y}(ORᵢ)_{z}(R₃)_{3-(y+z)}.

where: k can vary from 0 to 2, y can vary from 1 to 3, and z can vary from 0 to 2, 0<y+z<3, being that R₁ and R₂ are identical or different, and can be alkyl, linear or branched, cycloalkyl, aryl, alkylaryl, aralkyl or vinyl groups, in each case having 1 to 20 carbon atoms, mononuclear aryl groups, R₃ is H or alkyl, linear or branched, in each case having 1 to 20 carbon atoms, and A₂ is a spacer having up to 12 carbon atoms and may be linear or branched and preferably is selected from alkyl, allyl or vinyl.

In one embodiment the at least functional group is created by reacting reactive polymer chains with a silane sulfide modifier as described in WO2014/040639A1 or with an amino silane as described in EP2675278A1.

Preferably, the functional group comprises at least one terminal unit comprising at least one group selected from the groups selected from —OX, —OR, —COOX, —COOR, —SX, —N(R′₁) (R′₂) or a combination thereof, wherein X represents H or a cation, R represents a C₁-C₆ alkyl group, R′₁ and R′₂ represent independently from each other H, a C₁-C₁₀ alkyl group a —Si(R′₄) (R′₅) group where R′₄ and R'₅ represent independently from each other a C₁-C₁₀ alkyl group. In one embodiment of the present disclosure, the functional group does not comprise an -SX group. In one embodiment of the present disclosure the second functional group is obtainable by a reaction comprising adding a silicon-containing compound or a cyclic urea, or an alkylene oxide, or a combination thereof, to the polymerization reaction. Preferably the reaction product is treated with a suitable reagent to obtain at least one terminal unit selected from —OX, —OR, —COOX, —COOR, —SX, —N(R′₁) (R′₂) or a combination thereof, wherein X represents H or a cation, R represents a C₁-C₆ alkyl group, R′₁ and R′₂ represent independently from each other H, a C₁-C₂₀ alkyl group a —Si(R′₄)(R′₅) group where R′₄ and R′₅ represent independently from each other a C₁-C₂₀ alkyl group, preferably a C₁-C₆ alkyl group.

The silicon-containing compound preferably is selected from a divalent compound having one Si atom per molecule or a divalent compound being an open chain siloxane having 2 to 12 silicon atoms per molecule, or a cyclic siloxane having 3 to 12 silicon atoms per molecule, or a combination thereof. The remaining valences of said silicon atoms preferably are attached to an R radical wherein each R radical is selected independently from the group consisting of hydrogen, alkyl cycloalkyl, aryl aralkyl, alkaryl radicals having up to 20 carbon atoms wherein the radicals may, optionally, heterogroups connected to the carbon chain or the carbon ring selected from alkylamines and silylamines. Silicon-containing compounds include the cyclosiloxanes, according to the formula

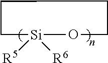

where R⁵ and R⁶ are the same or different and are each selected from H, a residue having from 1 to 20 carbon atoms, preferably selected from alkyl, cycloalkyl, aryl, alkaryl or aralkyl radical, wherein the radical may contain one or more heteroatoms, preferably O, N, S or Si, and preferably are selected from methyl. Specific examples include but are not limited to hexamethylcyclotrisiloxane, octamethylcyclotetrasiloxane, decamethylcyclopentasiloxane and dodecamethylcyclohexasiloxane, and mixtures of cyclosiloxanes of different ring sizes.

In one embodiment of the present disclosure the silicon-containing compound comprises from 2 to 20 unsaturated siloxane units, preferably from 3 to 15 unsaturated siloxane units, more preferably from 4 to 10 unsaturated siloxane units, corresponding to the general formula (1′):

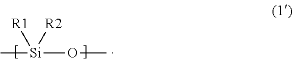

In formula (1′) each R1 independently represents an alkenyl selected from the group consisting of vinyl (—CH═CH₂), allyl (—CH—CH₂—CH═CH₂), n-propenyl (—CH₂CH═CH₂), n-butenyl (—CH₂CH₂CH═CH₂), isobutenyl (—CH₂(CH₃)CH═CH₂); n-pentenyl (—CH₂CH₂CH₂CH═CH₂), isopentenyl (—CH₂(CH₃)CH₂CH═CH₂, —CH₂CH₂(CH₃)CH═CH₂) and each R2 independently represents a chemical bond, H, OH, an alkenyl having from 2 to 10 carbon atoms, an alkyl having from 1 to 10 carbon atoms, wherein the alkyl or alkenyl chain or both may be interrupted once or more than once by an ether oxygen atom, or a siloxane or polysiloxane with up to 10 silicon atoms wherein the siloxane or polysiloxane may, optionally, have at least one silicone atom having at least one aliphatic substituent selected from alkyl or alkenyl groups or a combination thereof. Preferably, at least one R2 represents methyl. Preferably all R2 represent methyl or ethyl or combination thereof.

In one embodiment of the present disclosure the silicone-based compound contains at least one, preferably at least two, more preferably at least three units corresponding to the general formula (2′):

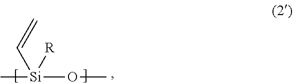

wherein R corresponds to R2 of formula (1′) above, i.e., R is selected from an alkyl having 1 to 10 carbon atoms and that may, optionally contain one more oxygen-ether atoms, and may be an alkoxy or polyalkoxy residue, or may, optionally contain one or more silane-groups, siloxane groups or polysiloxane groups wherein the polysiloxane or siloxane groups may contain from 1 to 3 alkyl or alkenyl residue on the silicon atoms and the maximum number of silicon atoms, preferably, is less than 10. Preferably, R is a C₁-C₁₀-alkyl group, more preferably a C₁-C₇-alkyl group and most preferably R is methyl.

In another preferred embodiment of the present disclosure the silicone-containing compound is cyclic and corresponds to the formula (3′)

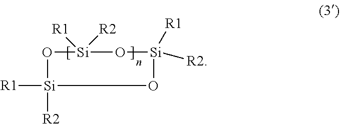

wherein n is 1, 2, 3 or 4, preferably n is 1 or 2, and each R1 is as described in formula (1) and preferably at least one, more preferably all R1 represent a vinyl (—CH═CH₂) group. Each R2 is as described in formula (1) above. Preferably at least one R2 is a C₁-C₇-alkyl group and more preferably at least one R2 is methyl. Most preferably all R2 represent a methyl group.

In one embodiment of the present disclosure the unsaturated siloxane coupling agent corresponds to the general formula (4′):

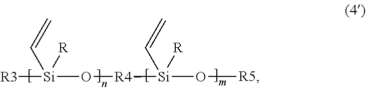

wherein n is an integer of 1 to 20 and m is integer of 1 to 20, and each residue R is selected independently from each other and is as described for formula (2) above, and
R3 is H, OH, a saturated or unsaturated hydrocarbon with 1 to 10 carbon atoms, a monovalent siloxane, polysiloxane or silane, or R3 connects to R5 to form a cyclic compound and represents a bivalent siloxane or polysiloxane with 1 to 10 silicon atoms and wherein one or at least one of the silicon atoms carries one or more alkyl or alkenyl residues having from 1 to 10 carbon atoms, or R3 and R5 jointly form a chemical bond to form a cyclic compound, and
R4 is a linker group selected from (i) aliphatic hydrocarbons having from 1 to 20 carbon atoms that may optionally contain one or more oxygen ether groups, (ii) one or more silane or siloxane groups or combinations thereof, wherein one or more than one silicon atom may carry one or more aliphatic hydrocarbon groups having from 1 to 10 carbon atoms or a combination of (i) and (ii), and
R5 is H, OH, a saturated or unsaturated hydrocarbon with 1 to 10 carbon atoms, a monovalent siloxane, polysiloxane or silane, or R5 is connected to R3 to form a cyclic compound and represents a bivalent siloxane or polysiloxane with 1 to 10 silicon atoms and wherein one or at least one of the silicon atoms carries one or more alkyl or alkenyl residues having from 1 to 10 carbon atoms, or R5 connects to R3 to form a cyclic compound and represents a bivalent siloxane or polysiloxane with 1 to 10 silicon atoms and wherein one or at least one of the silicon atoms carries one or more alkyl or alkenyl residues having from 1 to 10 carbon atoms, or R3 and R5 jointly form a chemical bond to form a cyclic compound.

In another embodiment of the present disclosure the silicone-containing compound corresponds to formula (5′):

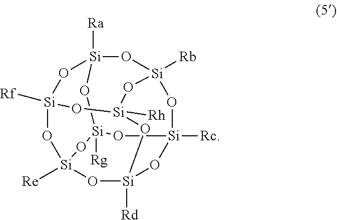

In formula (5′) Ra, Rb, Rc, Rd, Re, Rf, Rg and Rh are identical or different from each and are selected independently from each other a C₁-C₁₀-alkyl, a C₂-C₆-alkenyl, a —O—Si—(R₁R₂R₃), wherein R1′, R2′ and R3′ are selected independently from each other from a C₁-C₁₀-alkyl, a C₂-C₆-alkenyl, preferably vinyl, preferably at least one of R1′, R2′ and R3′ comprises a vinyl unit, preferably all of R1′, R2′ and R′3 are vinyl (—CH═CH₂). At least one, preferably at least two, more preferably at least three of Ra, Rb, Rc, Rd, Re, Rf, Rg and Rh comprises a C₂-C₆-alkenyl, preferably a vinyl (—CH═CH₂). In one embodiment of the present disclosure at least four of Ra-Rh are vinyl or at least one of residues Ra-Rh is —O—Si(vinyl)₃. In one embodiment of the present disclosure all of Ra-Rh are vinyl. Compounds according to formula (5′) are also known as polyhedral oligomeric silsesquioxanes or POSS. The materials are commercially available or can be prepared as described, for example, in Quirk, Cheng et al in Macromolecules 2012, 45, 21, 8571-8579.

Preferably, the coupling agent according to the present disclosure has a molecular weight of up to and including 5000 g/mol. Preferably the coupling agent has a molecular weight of less than 2000 g/mol.

Particularly preferred examples of coupling agents according to the present disclosure include

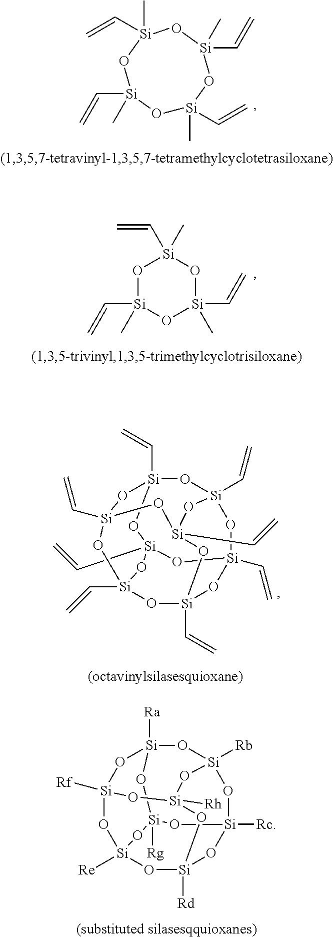

wherein residues Rb to Rg independently represent a C₁-C₇-alkyl, preferably a cyclopentyl, and Ra is —O—Si(—CH═CH₂)₃. Combinations of one or coupling agents according to the present disclosure may be used also.

Silicone-containing compounds also include one or more compounds that in addition to Si and O atoms comprise at least one N atom of an amino group or at least one S atom of a thiol group or a combination thereof. The amino- and the thiol-function may be protected, for example, by silyl groups and may be deprotected during work up or compounding. Specific examples include compounds according to the formulae

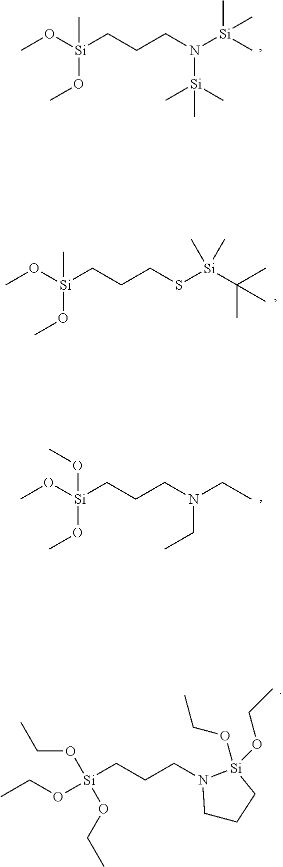

Homologues of these specific examples may be used, also. Homologues include but are not limited to the corresponding compounds where the propoylene group has been replaced by another alkylene group, including, for example, a C2 alkylene, a linear or branched C4-C10 alkylene, or, in addition or alternatively, where one or more methyl groups have been replaced independently from each other by another linear or branched C2-C8, preferably C2-C4, alkyl group, or where one or more ethyl group has been replaced by a C1 or a linear or branched C3-C8, preferably C3-C6, alkyl group.

In one embodiment the conjugated diene has been functionalized by a reaction comprising the addition of a cyclic urea as functionalization agent. The cyclic urea preferably corresponds to the general formula

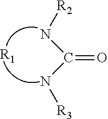

R₁ is selected from the group consisting of C₁-C₆-alkylenes that may be saturated, which is preferred, or unsaturated and that may be unsubstituted or substituted by one more substituent, a C₆-C₁₁ arylene that may be unsubstituted or substituted by one or more substituent, wherein the substituents are selected from alkoxy groups and oxyalkyl groups having from 1 to 6 carbon atoms and —SiO(Rx)₃ groups wherein each Rx represents independently an alkyl with 1 to 6 carbon atoms. Preferably R₁ is a C₁-C₃ alkylene, preferably unsubstituted and more preferably R₁ is —CH₂CH₂—. R₂, R₃ are identical or different and represent saturated or unsaturated organic radicals having from 1 to 24 carbon atoms and which may contain in addition to hydrogen one or more heteroatoms independently of one another selected from the group consisting of O, N, S and Si. For example, R₂ and R₃ may be selected from the group consisting of
(i) —C₁-C₂₄-alkyl, saturated or unsaturated, unsubstituted, mono- or polysubstituted; or
(ii) —C₁-C₂₄-heteroalkyl, saturated or unsaturated, unsubstituted, mono- or polysubstituted;
(iii) 6-24-membered aryl, unsubstituted, mono- or polysubstituted, wherein said 6-24-membered aryl is optionally connected through —C₁-C₆-alkylene- or —C₁-C₆-heteroalkylene-, in each case saturated or unsaturated, unsubstituted, mono- or polysubstituted;
(iv) 5-24-membered heteroaryl, unsubstituted, mono- or polysubstituted; wherein said 5-24-membered heteroaryl is optionally connected through —C₁-C₆-alkylene- or —C₁-C₆-heteroalkylene-, in each case saturated or unsaturated, unsubstituted, mono-or polysubstituted;
(v) 3-24-membered cycloalkyl, saturated or unsaturated, unsubstituted, mono-or polysubstituted; wherein said 3-24-membered cycloalkyl is optionally connected through —C₁-C₆-alkylene- or —C₁-C₆-heteroalkylene-, in each case saturated or unsaturated, unsubstituted, mono-or polysubstituted; and
(vi) 3-24-membered heterocycloalkyl, saturated or unsaturated, unsubstituted, mono- or polysubstituted; wherein said 3-24-membered heterocycloalkyl is optionally connected through —C₁-C₆-alkylene- or —C₁-C₆-heteroalkylene-, in each case saturated or unsaturated, unsubstituted, mono- or polysubstituted, wherein in each case “mono- or polysubstituted” means substituted with one or more substituents independently of one another selected C₁-C₁₈-alkyl which may be saturated or unsaturated and tri (C₁-C₁₈-) alkylsilyl. Preferably, R₂ and R₃ are selected from C₁-C₆-alkyl, more preferably from —CH₃ or —CH₂CH₃.

The reaction products may be treated with appropriate agents to introduce terminal units, for example least one terminal unit selected from —OX, —OR, —COOX, —COOR, —SX, —N(R′₁)(R′₂) or a combination thereof, wherein X represents H or a cation, R represents a C₁-C₆ alkyl group, R′₁ and R′₂ represent independently from each other H, a C₁-C₁₀ alkyl group a —Si(R′₄) (R′₅) group where R′₄ and R′₅ represent independently from each other a C₁-C₁₀ alkyl group. Appropriate agents include but are not limited to acids, alcohols, thioalcohols and combinations thereof. Carboxylic acid groups can be introduced, for example by treatment with a silalactone-based functionalization agent or an anhydride-based agent. The treatment with a silactone-based or anhydride-based treatment may also be carried out by direct reaction with reactive polymer chains. The functionalization of polymers is described for example in WO2021/009154; U.S. Pat. Nos. 3,242,129, 4,020,036, 4,465,809, US2016/0075809 A1 and US2016/0083495 A1 and WO2021/009154, all incorporated herein by reference.

Amino-functionalized initiators may be used to terminal groups having at least one amino-functional group at the alpha position of the polymer. Examples of suitable amino-functionalized initiators include 1-naphthyllithium, allyllithium compounds derived from tertiary N-allylamines, such as [1-(dimethylamino)-2-propenyl] lithium. [1-[bis (phenylmethyl)amino]-2-propenyl] lithium. [1-(diphenylamino)-2-propenyl] lithium, [1-(1-pyrrolidinyl)-2-propenyl] lithium, lithium amides of secondary amines, such as lithium pyrrolidide, lithium piperidide, lithium hexamethyleneimide, lithium 1-methylimidazolidide, lithium 1-methylpiperazide, lithium morpholide, lithium dicyclohexylamide, lithium dibenzylamide, lithium diphenylamide. These allyllithium compounds and these lithium amides can also be prepared in situ by reaction of an organolithium compound with the respective tertiary N-allylamines or with the respective secondary amines. Amine-functionalized monomers may also be used to generate amino-functionalized groups in alpha position of the polymer. They may be added before or at the start of the polymerization and/or during the polymerization but not at the end of the polymerization. The amine-functionalizing monomer may also be added as an active reaction product comprising at least two repeating units derived from the functionalizing monomer. Such active reaction product may be produced by a reaction of one or more amine-functionalized monomers with an organometal compound, for example an initiator for the anionic polymerization as described above, preferably an organo lithium compound, preferably an alkyl lithium and more preferably a butyllithium. The reaction may include an oligomerization of the amine-functionalized monomers, or a co-oligomerization of the amine-functionalized monomers and one or more other comonomers, for example conjugated dienes like those described above. Oligomerization or co-oligomerization may lead to oligomerized functionalizing monomers having 2 to 200 units derived from the amine-functionalized monomers. An active reaction product as referred to herein means that the monomer either has an intact carbon-carbon double bond that can participate in the polymerization reaction or a carbanion that can participate in the polymerization reaction or both. The reaction product may be created in a separate reaction and then added to the polymerization reactor, or it may be formed in situ, for example by co-feeding the one or more amine-functionalized monomer and reaction initiator into the polymerization reaction or by first reacting initiator and amine functionalized monomer before adding the conjugated diene monomers.

Examples of amine-functionalized monomers include but are not limited to those corresponding to formula (1″):

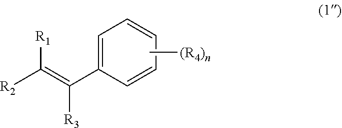

wherein R₁, R₂, R₃ are selected from hydrogen and methyl with the proviso that at least one of R₁, R₂ and R₃ is hydrogen, preferably R₁, R₂, and R₃ are all hydrogen,
n is 1, 2, 3, 4 or 5,
each R₄ is selected independently from an aliphatic, or aryl aliphatic residue having from 3 to 30 carbon atoms and wherein R₄ comprises at least one tertiary amine group if n is 1 and in case n is 2 to 5 at least one of the residues R₄ comprises at least one tertiary alkyl amine group. In one embodiment of the present disclosure R₄ is selected from a group represented

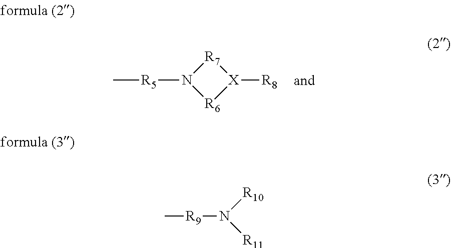

wherein in formula (2″) R₅ is selected from the group consisting of a chemical bond, a linear or branched alkylene group of 1 to 20 carbon atoms unsubstituted or substituted with a substituent, a cycloalkylene group of 5 to 20 carbon atoms unsubstituted or substituted with a substituent; or an arylene group of 6 to 20 carbon atoms unsubstituted or substituted with a substituent, wherein the substituent is an alkyl group of 1 to 10 carbon atoms, a cycloalkyl group of 5 to 10 carbon atoms, or an aryl group of 6 to 20 carbon atoms, R₆ and R₇ are each independently a cycloalkyl group of 5 to 10 carbon atoms, or an alkylene group of 1 to 20 carbon atoms unsubstituted or substituted with an aryl group of 6 to 20 carbon atoms, R8 is hydrogen; an alkyl group of 1 to 30 carbon atoms; an alkenyl group of 2 to 30 carbon atoms; an alkynyl group of 2 to 30 carbon atoms; a heteroalkyl group of 1 to 30 carbon atoms; a heteroalkenyl group of 2 to 30 carbon atoms; a heteroalkynyl group of 2 to 30 carbon atoms; a cycloalkyl group of 5 to 30 carbon atoms; an aryl group of 6 to 30 carbon atoms; or a heterocyclic group of 3 to 30 carbon atoms, and X is a chemical bond or an N, O or S atom, in case where X is O or S or a chemical bond R₈ is not present,
wherein in formula (3″) R₉ is an alkylene group of 1 to 20 carbon atoms unsubstituted or substituted with a substituent, a cycloalkylene group of 5 to 20 carbon atoms unsubstituted or substituted with a substituent; or an arylene group of 6 to 20 carbon atoms unsubstituted or substituted with a substituent, wherein the substituent is an alkyl group of 1 to 10 carbon atoms, a cycloalkyl group of 5 to 10 carbon atoms, or an aryl group of 6 to 20 carbon atoms, and R₁₁ and R₁₂ are each independently an alkyl group of 1 to 30 carbon atoms; an alkenyl group of 2 to 30 carbon atoms; an alkynyl group of 2 to 30 carbon atoms; a heteroalkyl group of 1 to 30 carbon atoms; a heteroalkenyl group of 2 to 30 carbon atoms; a heteroalkynyl group of 2 to 30 carbon atoms; a cycloalkyl group of 5 to 30 carbon atoms; an aryl group of 6 to 30 carbon atoms; or a heterocyclic group of 3 to 30 carbon atoms.

Specific examples include, but are not limited to,

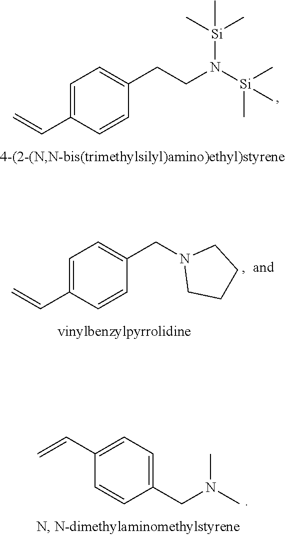

The conjugated diene polymers may be oil-extended and may contain up to 100 parts per 100 parts of polymer of extender oil. In case the polymers are oil-extended, i.e., the polymers have been combined with one or more extender oil prior or during work up of the polymer, typically before solvent removal, the composition also contains extender-oil as part of the oil-extended polymers. Polymers may be oil-extended when they have a high molecular weight. Polymers with high molecular weight have high Mooney viscosities. When the Mooney viscosity is too high, processing the polymers for making rubber compounds may become difficult or uneconomic. The Money viscosity of the polymers can be reduced by adding extender oils prior or during the work up of the polymers to provide oil-extended polymers. Typical amounts of extender oils are from 10 to 100 parts per 100 parts of polymer. Extender oils include oils as known and used for the oil-extension of diene rubbers and include oils such as TDAE (Treated Distillate Aromatic Extract)-, MES (Mild Extraction Solvates)-, RAE (Residual Aromatic Extract)-, TRAE (Treated Residual Aromatic Extract)-, naphthenic oil, paraffinic oils and hydrogenated versions thereof including oils obtained from plant-based materials including terpenes. They are preferably added to the reaction mixture prior or during solvent removal.

### Silica Fillers

The silica fillers according to the present disclosure are preferably precipitated silicas. Precipitated silicas are obtained by acidifying a caustic silicate solution to produce a slurry of the precipitated silica. Mineral acids may be used for the precipitation, for example sulfuric acid. The precipitated silicas are separated from the slurry, dried and optionally milled to desired particle sizes. The precipitated silicas are typically powders.

In conventional processes for producing precipitated silicas the caustic silicate solutions are made by fusing high purity soda ash and silica sand in furnaces at high temperatures. However, silicas can also be prepared from biomass. In such processes caustic silicate solutions are made by caustic digestion of biomass ash containing silica like rice husk. The ash is obtained from thermal pyrolysis of the biomass. Processes for making precipitated silicas are described, for example, in U.S. Pat. No. 6,375,735 B1, and references cited therein.

It has now been found that precipitated silicas with a certain distribution of alkali and earth alkali metal ions lead to tire compounds with improved performance parameters when combined with the conjugated diene polymers according to the present disclosure. Preferably, the silica filler has an ion number IN 1 of less than 3, or an ion number IN2 of less than 20, or both. The ion number N1 is calculated according to the formula:

$$IN 1 = [ ( Mg ) + ( K ) ] / [ ( Ca ) + ( Na ) ] \times 100.$$

The ion number IN2 is calculated according to the formula:

$$IN 2 = [ ( Mg ) + ( Na ) ] / [ ( Ca ) + ( K ) ] \times 100.$$

In both formulae:
(Mg) is the concentration of magnesium ions in mg/kg of silica sample divided by the atomic weight of magnesium (24 g/mol), i.e., c (Mg²⁺)/24 g/mol;
(K) is the concentration of potassium ions in mg/kg of silica sample divided by the atomic weight of potassium (39 g/mol), i.e., c (K⁺)/39 g/mol;
(Ca) is the concentration of calcium ions in mg/kg silica sample divided by the atomic weight of calcium (40 g/mol);
(Na) is the concentration of sodium ions in mg/kg silica sample divided by the atomic weight of sodium (23 g/mol).

Preferably, the silica filler has a potassium content of greater than 100 mg/kg silica sample, a magnesium content of greater than 100 mg/kg silica sample or both.

It is believed that silicas obtained from biomass ash, in particular rice husk ash, have such a cation distribution. Conventional silicas have a different cation distribution and generally contain fewer cations. However, such cations may be added to conventional silicas to create a cation profile described above.

The silica filler according to the present disclosure preferably is precipitated silica obtained from biomass ash, preferably from a biomass ash containing rice husk ash. Preferably, the filler is obtained by a process comprising a caustic digestion of biomass ash, preferably rice husk ash. The ash is preferably obtained from thermal pyrolysis of the biomass. Preferably, the caustic silicate solution is acidified, preferably by at least one mineral acid to produce a slurry of the precipitated silica and the process further comprises separating the precipitated silicas from the slurry.

Precipitated silicas are predominantly or entirely amorphous. Preferably, the silica filler according to the present disclosure has a content of SiO₂ of at least 80% by weight, preferably at least 85% by weight, based on the total weight of the filler. Preferably the silica filler has a surface area (BET) of 30 to 300 m²/g or from 30 to less than 190 m²/g.

The filler according to the present disclosure may be used with the functionalized polymers according to the present disclosure in a weight ratio of silica to polymer from 5:1 to 1:5, preferably from 2:1 to 1:2.

The silica fillers according to the present disclosure can be used alone or in a mixture with other silica filler or with one or more filler that is not a silica filler. In one embodiment of the present disclosure the rubber compositions contain a mixture of silica fillers according to the present disclosure and one or more carbon-based fillers including carbon black. The weight ratio of silica fillers to carbon-based filler may be from 0.01:1 to 50:1, preferably from 0.05:1 to 20:1. Examples of suitable carbon-based fillers include but are not limited to carbon blacks produced by the flame soot, channel, furnace, gas soot, thermal, acetylene soot or arc process. The carbon-based fillers may have BET surfaces of 9-200 m²/g. Examples of specific carbon blacks include but are not limited to SAF-, ISAF-LS-, ISAF-HM-, ISAF-LM-, ISAF-HS-, CF-, SCF-, HAF-LS-, HAF-, HAF-HS-, FF-HS-, SPF-, XCF-, FEF-LS-, FEF-, FEF-HS-, GPF-HS-, GPF-, APF-, SRF-LS-, SRF-LM-, SRF-HS-, SRF-HM- and MT-soot or according to ASTM N110-, N219-, N220-, N231-, N234-, N242-, N294-, N326-, N327-, N330-, N332-, N339-, N347-, N351-, N356, N358, N375, N472, N539, N550, N568, N650, N660, N754, N762, N765, N774, N787 and N990 carbon blacks. Carbon-based fillers obtained from a sustainable source, for example from recycling of rubber or plastic waste including carbon-based material obtained from the pyrolysis of tires, may also be used.

Examples of suitable fillers that are neither silicas nor carbon-based include but are not limited to glass fibers and glass fiber products (mats, strands) or microspheres; metal oxides including zinc oxide, calcium oxide, magnesium oxide, aluminum oxide; metal carbonates including magnesium carbonate, calcium carbonate, zinc carbonate; metal hydroxides including aluminum hydroxide, magnesium hydroxide; metal sulfates including calcium sulfate, barium sulfate; rubber gels including those based on BR, E-SBR and/or polychloroprene, preferably with particle sizes from 5 to 1000 nm.

### Additional Rubbers and Rubber Additives

The polymers and silicas according to the present disclosure can be used to make vulcanizable rubber compounds by a process comprising combining the polymers and silica filler with one or more cross-linking agent for cross-linking at least the conjugated diene polymer. Therefore, in one aspect of the present disclosure there is provided a process of making a vulcanizable rubber compound comprising combining a polymer according to the present disclosure with at least one silica filler according to the present disclosure, and, optionally, further comprising combining at least one curing agent capable of curing the at least diene polymer or a combination thereof, and, optionally, combining one or more additional rubbers and/or rubber additives.

The rubber compounds according to the present disclosure may further contain one or more additional rubbers other than the functionalized rubbers according to the present disclosure and at least one rubber additive.

Additional rubbers include, for example, natural rubber and synthetic rubber. If present, they may be used in amounts in the range from 0.5 to 95% by weight, preferably in the range from 10 to 80% by weight, based on the total amount of rubber in the composition. Examples of suitable synthetic rubbers include BR (polybutadiene), acrylic acid alkyl ester copolymers, IR (polyisoprene), E-SBR (styrene-butadiene copolymers produced by emulsion polymerization), S-SBR (styrene-butadiene copolymers produced by solution polymerization), IIR (isobutylene-isoprene copolymers), NBR (butadiene-acrylonitrile copolymers), HNBR (partially or completely hydrogenated NBR rubber), EPDM (ethylene-propylene-diene terpolymers) and mixtures thereof. Natural rubber, E-SBR and S-SBR with a glass temperature above −60° C., polybutadiene rubber with a high cis content (>90%) produced with catalysts based on Ni, Co, Ti or Nd, polybutadiene rubber with a vinyl content of up to 80% and mixtures thereof are of particular interest for the manufacture of automotive tires.

Rubber additives are ingredients that may improve the processing properties of the rubber compositions, serve to crosslink the rubber compositions, improve the physical properties of the vulcanizates produced from the rubber, improve the interaction between the rubber and the filler or serve to bond the rubber to the filler. Rubber auxiliaries include crosslinking agents such as sulfur or sulfur-supplying compounds, reaction accelerators, antioxidants, heat stabilizers, light stabilizers, ozone stabilizers, processing aids, plasticizers, tackifiers, blowing agents, dyes, pigments, waxes, extenders, organic acids, silanes, retarders, metal oxides, extender oils such as DAE (Distillate Aromatic Extract)-, TDAE (Treated Distillate Aromatic Extract)-, MES (Mild Extraction Solvates)-, RAE (Residual Aromatic Extract)-, TRAE (Treated Residual Aromatic Extract)-, naphthenic and heavy naphthenic oils as well as activators. Oils obtained from a sustainable source, including a renewable source or a recycled material, may also be used. Oils obtained from at least one renewable source include oils obtained from plants, including vegetable oil, or oils produced from microbes or by enzymes.

The total amount of additional rubber and rubber additives may range from 1 to 300 parts by weight, preferably from 5 to 150 parts by weight based on 100 parts of the conjugated diene polymer according to the present disclosure.

Examples of typical formulations of rubber compounds include those shown in US2016/0075809 A1 and US2016/0083495 A1 (Steinhauser and Gross) and in international patent application WO2021/009154 (Steinhauser).

The rubber compositions can be prepared with conventional processing equipment for making and processing of (vulcanizable) rubber compounds and include rollers, kneaders, internal mixers or mixing extruders. The rubber compositions can be produced in a single-stage or a multi-stage process, with 2 to 3 mixing stages being preferred. Cross-linking agents, for example sulfur, and accelerators may be added in a separate mixing stage, for example on a roller, with temperatures in the range of 30° C. to 90° C. being preferred. Cross-linking agent, for example sulfur, and accelerator are preferably added in the final mixing stage.

### Applications

The vulcanizable rubber compounds can be subjected to at least one curing reaction to produce a shaped article. The shaped article contains the compound or at least the conjugated diene polymer in vulcanized, i.e., cross-linked form.

Therefore, in one aspect there is provided an article obtained from curing a rubber compound according to the present disclosure. The process may comprise at least one shaping step wherein the shaping may take place prior to, during or after the curing. Preferably, the rubber compounds according to the present disclosure are used for making tires or tire treads and preferred articles include tires, preferably tire treads. However, the rubber compounds provided herein are also suitable for the manufacture of other articles, in particular other molded articles, for example for the manufacture of cable sheaths, hoses, drive belts, conveyor belts, roll linings, shoe soles, sealing rings and damping elements.

The following examples are provided to further illustrate the present disclosure without, however, intending to limit the disclosure to the embodiments set forth in these examples.

### Methods

### Composition of Silica Samples

The composition of the silica samples was determined by X-ray fluorescence (XRF). For determining the cation content of the cations used calculating the ion number. 0.5 g of the silica samples were digested by dry ashing at 550° C. in a platinum crucible with subsequent distillation of the ash in hydrochloric acid. After appropriate dilution of the digestion solution with deionized water, the metal contents are measured by ICP-OES (inductively coupled plasma-optical emission spectrometry) at the following wavelengths:
calcium: 317.933 nm,
magnesium: 285,213 nm,
potassium: 766.491 nm,
sodium: 589.592 nm
against calibration solutions matched to the acid matrix. Depending on the concentration of the elements in the digestion solution and the sensitivity of the measuring instrument used, the concentrations of the sample solutions were matched to the linear region of the calibration for the wavelengths used in each case. The BET surface area can be determined using nitrogen gas according to ISO9277 or ISO18852.

### Ion Number:

The ion number 1 (IN1) was calculated according to formula (1):

$$IN 1 = [ ( Mg ) + ( K ) ] / [ ( Ca ) + ( Na ) ] \times 100.$$

The ion number 2 (IN2) was calculated according to formula (2):

$$IN 2 = [ ( Mg ) + ( Na ) ] / [ ( Ca ) + ( K ) ] \times 100.$$

In formula 1 and 2:
(Mg) is the concentration of magnesium ions in mg/kg of silica sample divided by the atomic weight of magnesium (24 g/mol), i.e., c (Mg²⁺)/24 g/mol;
(K) is the concentration of potassium ions in mg/kg of silica sample divided by the atomic weight of potassium (39 g/mol), i.e., c (K⁺)/39 g/mol;
(Ca) is the concentration of calcium ions in mg/kg silica sample divided by the atomic weight of calcium (40 g/mol);
(Na) is the concentration of sodium ions in mg/kg silica sample divided by the atomic weight of sodium (23 g/mol).

### Molecular Weights

The molecular weight of the polymer (Mw and Mn, respectively the weight average and the number average molecular weight momenta) were determined by gel permeation chromatography.

### Properties of Vulcanized Compounds

The loss factors tan o were measured at 0° C. and at 60° C. to determine the temperature-dependent dynamic-mechanical properties. An EPLEXOR device (Eplexor 500 N) from GABO was used for this purpose. The measurements were carried out in accordance with DIN 53513 at 10 Hz on Ares strips in the temperature range from −100° C. to 100° C.

Rebound resilience at 60° C. was determined according to DIN 53512.

Tensile strength tests were performed on the vulcanized S2 test specimens according to DIN 53504.

Elastic properties were determined according to DIN53513-1990. An elastomer test system (MTS Systems GmbH, 831 Elastomer Test System) was used. The measurements were carried out in double shear mode with no static pre-strain in shear direction and oscillation around 0 on cylindrical samples (2 samples each 20×6 mm, pre-compressed to 5 mm thickness) and a measurement frequency of 10 Hz in the strain range from 0.1 to 40%. The method was used to obtain the following properties:
G′ (0.5%): dynamic modulus at 0.5% amplitude sweep, G′ (15%): dynamic modulus at 15% amplitude sweep, G′=G′(0.5%)−G′ (15%): difference of dynamic modulus at 0.5% relative to 15% amplitude sweep, tan δ (max): maximum loss factor (G″/G′) of entire measuring range at 60° C.

The difference of G′(0.5%)−G′(15%) is an indication of the Payne effect of the mixture. The lower the value the better the distribution of the filler in the mixture, the better the rubber-filler interaction and the lower the risk of phase separation.

### Examples C1-C4 and Ex1, Ex2 and Ex3

Conjugated diene polymers (polymers 1 and 2) were mixed with different silica in a tire tread formulation and subjected to curing. Polymer 1 was a non-functionalized styrene-butadiene copolymers. Polymer 2 was a styrene-butadiene copolymer of similar composition but functionalized to have a terminal, polar siloxane-units comprising carboxylate end group. Silica 1 was a conventional precipitated silica (ULTRASIL 7000GR, surface area (N2)=175 m2/g). Silica 2 was a conventional precipitated silica (ZEOZIL1165 MP) with a surface area (BET) of 165 m²/g. Silicas 3 and 4 were obtained from rice husk ash and had a surface area (BET) of 145-175 m²/g and 160+/−10 m²/g, respectively (ORYZAZL HD165MP and BSIL 2160MP, respectively). In Example 3 a styrene-butadiene polymer was used that was functionalized to contain a terminal amino group. The composition of the silicas is shown in tables 1 and 2. The compound compositions are shown in table 3. The compounds were subjected to curing to produce vulcanized compositions. The properties of the vulcanizates are shown in table 4.

TABLE 1
composition of silica samples

| | S1 | S2 | S3 | S3bis* | S4 |
|---|---|---|---|---|---|
| semiquantitative XRF | | | | | |
| SiO2 (% wt) | 96.7 | 98.5 | 97.2 | 97.1 | 89.6 |
| Na2O (% wt) | 1.4 | 0.69 | 0.87 | 0.97 | 4.6 |
| SO3 (% wt) | 1.1 | 0.6 | 0.96 | 0.96 | 5 |
| aluminum oxide | 0.55 | 0.1 | 0.82 | 0.87 | 0.12 |
| (% wt) | | | | | |
| F2O3 (% wt) | 0.09 | 0.05 | 0.05 | 0.05 | 0.15 |
| calcium oxide (% wt) | 0.03 | 0.03 | 0.02 | 0.02 | 0.03 |
| ICPOES | | | | | |
| C (wt %) | <0.3 | <0.3 | <0.3 | <0.5 | 0.84 |
| N (wt %) | 0.07 | 0.05 | <0.05 | | |
| S (wt %) | 0.26 | 0.29 | 0.39 | | |
| Cl (mg/kg) | 110 | 200 | 32 | 18 | 2300 |
| Al (mg/kg) | 300 | 3600 | 6400 | 5200 | 590 |
| Ca (mg/kg) | 280 | 470 | 320 | 300 | 890 |
| Fe (mg/kg) | 210 | 160 | 120 | 110 | 220 |
| K (mg/kg) | 70 | 25 | 370 | 360 | 1000 |
| Cu (mg/kg) | <1 | <1 | 2 | 3 | <1 |
| Li (mg/kg) | <1 | <1 | 3 | 3 | <1 |
| Mg (mg/kg) | 79 | 76 | 160 | 150 | 600 |
| Na (mg/kg) | 4500 | 7400 | 6000 | 5600 | 20000 |
| Si (wt %) | 38 | 32 | 36 | 36 | 37 |

*repeat experiment of S3.

TABLE 2
ion number of the silicas

| | S1 | S2 | S3 | S3bis | S4 |
|---|---|---|---|---|---|
| (Ca) | 7 | 11.75 | 8 | 7.5 | 22.25 |
| (Mg) | 3.3 | 3.2 | 6.7 | 6.3 | 25.0 |
| (Na) | 195.7 | 321.7 | 260.9 | 243.5 | 869.6 |
| (K) | 1.79 | 0.64 | 9.49 | 9.23 | 25.64 |
| IN1 | 2.51 | 1.14 | 5.01 | 6.17 | 5.86 |
| IN2 | 22.6 | 26.2 | 15.3 | 14.9 | 18.7 |

TABLE 3
Compound recipes.

| | C1 | C2 | C3 | C4 | C5 | C6 | Ex 1 | Ex2 | Ex3 |
|---|---|---|---|---|---|---|---|---|---|
| Polymer 1 | 96.3 | 96.3 | 96.3 | 96.3 | | | | | |
| Polymer 2 | | | | | 73.5 | 73.5 | 73.5 | 73.5 | |
| Polymer 3 | | | | | | | | | 70 |
| Silica 1 | 90 | | | | 90 | | | | |
| Silica 2 | | 90 | | | | 90 | | | |
| Silica 3 | | | 90 | | | | 90 | | 90 |
| Silica 4 | | | | 90 | | | | 90 | |
| BUNA CB24 | 30 | 30 | 30 | 30 | 30 | 30 | 30 | 30 | 30 |
| (polybutadiene) | | | | | | | | | |
| VULCAN J/375 | 5 | 5 | 5 | 5 | 5 | 5 | 5 | 5 | 5 |
| (carbon black) | | | | | | | | | |
| VIVATEC 500 | 4.7 | 4.7 | 4.7 | 4.7 | 27.5 | 27.5 | 27.5 | 27.5 | 31 |
| (process oil) | | | | | | | | | |
| AFLUX 37 | 3 | 3 | 3 | 3 | 3 | 3 | 3 | 3 | 3 |
| VULCANOX | 2 | 2 | 2 | 2 | 2 | 2 | 2 | 2 | 2 |
| HS LG | | | | | | | | | |
| ANTILUX 654 | 2 | 2 | 2 | 2 | 2 | 2 | 2 | 2 | 2 |
| (wax) | | | | | | | | | |
| SI69 Silane | 7.2 | 7.2 | 7.2 | 7.2 | 7.2 | 7.2 | 7.2 | 7.2 | 7.2 |
| Sulfur | 1.7 | 1.7 | 1.7 | 1.7 | 1.7 | 1.7 | 1.7 | 1.7 | 1.7 |
| ZnO | 3 | 3 | 3 | 3 | 3 | 3 | 3 | 3 | 3 |
| stearic acid | 1 | 1 | 1 | 1 | 1 | 1 | 1 | 1 | 1 |
| RHENOGRAN | 2.5 | 2.5 | 2.5 | 2.5 | 2.5 | 2.5 | 2.5 | 2.5 | 2.5 |
| DPG 80 | | | | | | | | | |
| RHENOGRAN | 2 | 2 | 2 | 2 | 2 | 2 | 2 | 2 | 2 |
| TBBS 80 | | | | | | | | | |

TABLE 4
Compound properties

| | C1 | C2 | C3 | C4 | C5 | C6 | Ex1 | Ex2 | Ex3 |
|---|---|---|---|---|---|---|---|---|---|
| ML 1 + 4 | 74.2 | 78.8 | 76.8 | 65.2 | 79.6 | 83.7 | 87 | 68.1 | 68.6 |
| tanδ (0° C.) | 0.314 | 0.281 | 0.26 | 0.275 | 0.301 | 0.289 | 0.309 | 0.317 | 0.164 |
| tanδ (60° C.) | 0.09 | 0.095 | 0.091 | 0.092 | 0.085 | 0.095 | 0.075 | 0.08 | 0.64 |
| tanδ (0° C.)/ | 3.49 | 2.96 | 3.08 | 2.99 | 3.54 | 3.04 | 4.12 | 3.96 | 2.56 |
| tanδ (60° C.) | | | | | | | | | |
| tanδ max, T | 0.565 | 0.471 | 0.49 | 0.57 | 0.585 | 0.508 | 0.577 | 0.629 | 0.682 |
| sweep | | | | | | | | | |
| Rebound at | 58 | 55.5 | 58.5 | 58.5 | 58.5 | 59.5 | 62.5 | 61.5 | |
| 60° C. [%] | | | | | | | | | |
| tanδ max, | 0.174 | 0.176 | 0.153 | 0.164 | 0.157 | 0.162 | 0.14 | 0.137 | 0.142 |
| ampl. sweep | | | | | | | | | |
| Payne effect | 1.5 | 1.8 | 1.3 | 1.6 | 1.2 | 1.7 | 0.9 | 0.7 | 0.8 |
| [MPa] | | | | | | | | | |
| Tensile | 2.4 | 2.9 | 2.8 | 2.5 | 2.5 | 3 | 2.6 | 2.4 | 2.8 |
| S100 [MPa] | | | | | | | | | |
| Tensile | 14.4 | 16.8 | 17 | 12.7 | 15 | 17.4 | 16.8 | 13 | 17.1 |
| S300 [MPa] | | | | | | | | | |
| S300/S100 | 6.00 | 5.79 | 6.07 | 5.08 | 6.00 | 5.80 | 6.46 | 5.42 | 6.1 |

The comparison of compounds of non-functionalized SSBR and conventional silica with compounds of non-functionalized SSBR and silicas obtained from biomass ash (C1 and C3), shows only minor changes in energy dissipation e.g., rebound at 60° C., tan delta (0° C.)/tan delta (60° C.) and reinforcement S300/S100. In case of C4, a trade-off between improved dynamic properties and reduced tensile properties was observed. Substituting the non-functionalized SSBR with functionalized SSBR in compounds with conventional silica shows an improvement of dynamic properties while the reinforcement parameter remained constant (C5, C6). A combination of functionalized SSBR with silica obtained from biomass ash (Ex 1 vs C1, C3, C5 and Ex 2 vs C4) showed a further improvement of dynamic properties: a beneficial wet grip/rolling resistance balance (tan d 0° C./tan d 60° C.), increased rebound at 60° C. and improved filler dispersion (Payne Effect). Good values, including a low value for the Payne Effect, which is advantageous as it shows improved dispersion with the filler, were also achieved in Ex 3. Additionally, the reinforcement parameter (S300/S100) also improved (Ex 1 vs C1, C3, C5 and Ex 2 vs C4).

1. A method of making a rubber compound comprising combining a conjugated diene polymer and a silica filler, wherein the silica filler has a content of SiO₂ of at least 80% by weight based on the weight of the filler and is obtained from a biomass ash comprising rice husk ash and wherein the conjugated diene polymer is a homopolymer of a conjugated diene or a copolymer of at least one conjugated diene selected from the group consisting of butadiene, isoprene, 1,3-pentadiene, 2,3-dimethylbutadiene, 1-phenyl-1,3-butadiene, 1,3-hexadiene, and wherein the polymer is functionalized and comprises at least one functional group that comprises at least one polar group selected from —OX, —OR, —COOX, —COOR, —N(R′₁) (R′₂)Xₙ or a combination thereof, wherein X represents H or a cation, n is either 1 or 0 and in case n is 1 the nitrogen atom N is positively charged, R represents a C1-C6 alkyl group, R′₁ and R′₂ represent independently from each other H, a C1-C6 alkyl group a —Si(R′₄) (R′₅) group where R′₄ and R′₅ represent independently from each other a C1-C6 alkyl group.

2. The method according to claim 1 wherein the at least one polar group is selected from —COOX, —N(R′₁)(R′₂)Xₙ or a combination thereof, wherein X represents H or a cation, n is either 1 or 0 and in case n is 1 the nitrogen atom N is positively charged, R′₁ and R′₂ represent independently from each other H, a C₁-C₆ alkyl group a —Si(R′₄)(R′₅) group where R′₄ and R′₅ represent independently from each other a C₁-C₆ alkyl group.

3. The method according to claim 1, wherein the functional group comprises, from 1 to 20 Si atoms in addition to carbon and hydrogen atoms.

4. The method according to claim 1, wherein the functional group has a unit selected from the formulae (I) or (II) or a combination thereof:
*—Si(R¹)(R²)—C(R³)(R⁴)— (I),
*—Si(R¹)(R²)—O—Si(R³)(R⁴)— (II)
wherein in formula (I) and (II) R¹, R², R³, R⁴ are identical or different and are selected from hydrogen or C₁-C₁₂ alkyl groups that, optionally, comprise heteroatoms selected from O, N, S, and Si, and wherein *-indicates a bond to a polymer chain, wherein at least one of R¹ and R² may also represent a polymer chain.

5. The method according to claim 1, wherein the functional group is obtained by a reaction with at least functionalizing agent to produce functional end groups or a coupling agent or a combination thereof.

6. The method according to claim 1, wherein the functional group comprises from 1 to 12 silicon atoms and from 1 to 30 carbon atoms.

7. The method according to claim 1, wherein the conjugated diene polymer is a copolymer comprising units derived from butadiene and at least one other conjugated diene or at least one vinyl aromatic comonomer or a combination thereof, wherein the vinyl aromatic comonomer is selected from styrene, ortho-methyl styrene, meta-methyl styrene, para-methyl styrene, para-tertbutyl styrene, vinyl naphthalene.

8. The method according to claim 1, wherein the conjugated diene polymer comprises units derived from butadiene and styrene and wherein the polymer is prepared by anionic solution polymerization.

9. The method according to claim 1, wherein the silica filler has an ion number IN 1 of less than 3, an ion number IN 2 of less than 20, or both, wherein IN 1 is calculated according to the formula:
$$IN 1 = [ ( Mg ) + ( K ) ] / [ ( Ca ) + ( Na ) ] \times 100 ,$$
and wherein IN2 is calculated according to the formula:
$$IN 2 = [ ( Mg ) + ( Na ) ] / [ ( Ca ) + ( K ) ] \times 100 ,$$
and wherein in both formulae
(Mg) is the concentration of magnesium ions in mg/kg of silica sample divided by the atomic weight of magnesium (24 g/mol);
(K) is the concentration of potassium ions in mg/kg of silica sample divided by the atomic weight of potassium (39 g/mol);
(Ca) is the concentration of calcium ions in mg/kg silica sample divided by the atomic weight of calcium (40 g/mol);
(Na) is the concentration of sodium ions in mg/kg silica sample divided by the atomic weight of sodium (23 g/mol).

10. The method according to claim 1, wherein the silica filler has a potassium content of greater than 100 mg/kg silica sample, a magnesium content of greater than 100 mg/kg silica sample or both.

11. The method according to claim 1, wherein the silica filler is present in a weight ratio to the conjugated diene polymer of from 5:1 to 1:5.

12. The method according to claim 1, further comprising combining the polymer and the silica filler with at least one curing agent.

13. A rubber compound obtained by the method according to claim 1.

14. An article obtained by a process comprising curing the rubber compound of claim 13 and wherein the process comprises at least one shaping step wherein the shaping may take place prior to, during or after the curing.

15. The article of claim 14, wherein the article is selected from a tire tread, a tire, or a combination thereof.
